(19) United States
(12) Patent Application Publication
(10) Pub. No.: US 2025/0225648 A1
(43) Pub. Date: Jul. 10, 2025

(54) PRESS MACHINE

(71) Applicant: G-TEKT CORPORATION, Saitama-shi, Saitama (JP)

(72) Inventor: Kyo SHIBATA, Fukaya-shi, Saitama (JP)

(21) Appl. No.: 18/879,497

(22) PCT Filed: May 26, 2023
(86) PCT No.: PCT/JP2023/019703

§ 371 Date: Dec. 27, 2024

(30) Foreign Application Priority Data
Jul. 5, 2022 (JP) 2022-108484
Jul. 5, 2022 (JP) 2023-074446

(51) Int. Cl. G06T 7/00; B29C 37/00; G06T 7/73; H04N 23/90

(52) U.S. Cl. CPC G06T 7/001; B29C 37/00; G06T 7/74; H04N 23/90; B29C 2037/906; G06T 2207/20081; G06T 2207/30116; G06T 2207/30168

(57) ABSTRACT

A press machine includes a press unit 101, a conveyance unit (102), a frame (103), an image capturing unit (104), a sensor (105), a controller (106), an inspection circuit (107), and a display (108). The frame (103) is arranged outside the press unit (101) The frame (103) includes a first leg (111a) and a second leg (111b), which are installed on a floor (161) on both sides of the conveyance unit (102), and a beam (112) laid between the first leg (111a) and the second leg (111b) while straddling the conveyance unit (102). The image capturing unit (104) is attached to the frame (103) installed on the floor (161) on both sides of the conveyance unit (102).

### TECHNICAL FIELD

The present invention relates to a press machine.

### BACKGROUND ART

For example, in manufacturing of an automobile part such as a dashboard lower part, appearance inspection of a press-formed part unloaded from a press machine is manually performed. Since press-formed parts are unloaded from the press machine at a production speed of about 14 to 25 pieces/min, there are limitations in handling these at a manual processing speed, and many problems, are posed such that much labor is required. For this reason, mechanization of appearance inspection of parts has been examined. When mechanizing appearance inspection of this type, generally, an inspection target part is captured by a camera to acquire an image, and the obtained image is arithmetically processed, thereby executing inspection (see patent literature 1).

### RELATED ART LITERATURE

### Patent Literature

Patent Literature 1: Japanese Patent No. 6016515

### DISCLOSURE OF INVENTION

### Problem to be Solved by the Invention

However, if the camera is simply attached to the press machine, a large vibration is generated in a state in which the press machine is operating. For this reason, the camera may be unable to correctly capture the inspection target, and inspection may be impeded.

The present invention has been made to solve the above-described problem, and has as its object to enable execution of appearance inspection while suppressing the influence of a vibration generated from an operating press machine.

### Means of Solution to the Problem

According to the present invention, there is provided a press machine comprising a conveyance unit configured to convey, up to an unloading port, a pressed article that is press-worked by a press unit, dropped to a discharge region below the press unit, and discharged, and is not in a predetermined posture, a frame installed outside the press unit, an image capturing unit installed on the frame and configured to capture an inspection region of the conveyance unit, a sensor configured to detect that the pressed article conveyed by the conveyance unit reaches the inspection region, a controller configured to, when the sensor detects that the pressed article reaches the inspection region, start image capturing by the image capturing unit and acquire an image of the pressed article passing through the inspection region, an inspection circuit configured to inspect an outer appearance of the pressed article based on the image of the pressed article acquired by the controller, and a display configured to display an inspection result by the inspection circuit, wherein the inspection circuit decides a posture of the pressed article based on a feature part of the pressed article, the feature part is at least one of center coordinates of a plurality of holes, characteristic shape coordinates, and shape coordinates of a part end portion, and the inspection circuit recognizes the posture of the pressed article in the captured image of the pressed article based on the feature part, and executes quality determination of the outer appearance of the pressed article based on machine learning data obtained by machine learning corresponding to the recognized posture.

In a configuration example of the press machine, the posture of the pressed article is the posture of the pressed article that is press-worked, extracted by a robot arm, dropped onto the conveyance unit in the discharge region, and discharged.

In a configuration example of the press machine, the inspection circuit decides the posture of the pressed article based on coordinate information of the feature part in an image capturing range of the image capturing unit.

In a configuration example of the press machine, the inspection circuit associates information of a posture with results of image capturing of the pressed article in various posture states by the image capturing unit based on the coordinates of the decided feature part, creates an OK determination model and an NG determination model for each associated posture, and performs learning.

In a configuration example of the press machine, the inspection circuit compares the image captured by the image capturing unit and one of an OK determination model and an NG determination model with a matching posture by image analysis software, thereby determining that the captured pressed article is non-defective or defective.

In a configuration example of the press machine, the NG determination model includes an NG model by the feature part having a different shape, an NG model by the feature part with a position deviation, and an NG model including a crack.

In a configuration example of the press machine, the image capturing unit comprises a plurality of cameras and captures the inspection region from above, from sides, from an upstream side, and from a downstream side, and the inspection circuit inspects the outer appearance of the pressed article using a plurality of captured images.

In a configuration example of the press machine, at least one of the plurality of cameras is installed using a bracket to enter a side of the discharge region of the press unit.

In a configuration example of the press machine, the inspection circuit associates information of a posture with results of image capturing of the pressed article in various posture states by the plurality of cameras based on the coordinates of the decided feature part, creates an OK determination model and an NG determination model for each associated posture, performs learning, and compares the image and one of an OK determination model and an NG determination model with a matching posture by image analysis software, thereby determining that the pressed article is non-defective or defective.

In a configuration example of the press machine, the frame is installed outside a press unit foundation on which the press unit is installed, and comprises legs that are installed on a floor on both sides of the conveyance unit, and a beam that is laid between the legs while straddling the conveyance unit, and the image capturing unit comprises a first camera attached to the beam and configured to capture the inspection region from above, a second camera attached to a first bracket that is supported by the beam and enters the discharge region, and configured to capture the inspection region from the upstream side of the conveyance unit, a third camera attached to a second bracket that is supported by the beam and extends in a direction of the unloading port, and configured to capture the inspection region from the downstream side of the conveyance unit, and a fourth camera and a fifth camera, which are attached to the legs and configured to capture the inspection region from both sides with respect to a conveyance direction of the conveyance unit.

### Effect of the Invention

As described above, according to the present invention, since the image capturing unit is attached to the frame installed outside the press unit, appearance inspection can be executed while suppressing the influence of a vibration generated from the operating press unit.

### BRIEF DESCRIPTION OF DRAWINGS

FIG. 1 is a diagram showing the configuration of a press machine according to the embodiment of the present invention;

FIG. 2A is a diagram showing a partial configuration of the press machine according to the embodiment of the present invention;

FIG. 2B is a diagram showing a partial configuration of the press machine according to the embodiment of the present invention;

FIG. 2C is a perspective view showing a partial configuration of the press machine according to the embodiment of the present invention;

FIG. 3A is an explanatory view for explaining quality determination in an inspection circuit 107;

FIG. 3B is an explanatory view for explaining quality determination in the inspection circuit 107;

FIG. 3C is an explanatory view for explaining quality determination in the inspection circuit 107;

FIG. 3D is an explanatory view for explaining quality determination in the inspection circuit 107; and

FIG. 4 is an explanatory view for explaining quality determination corresponding to a recognized posture in the inspection circuit 107.

### BEST MODE FOR CARRYING OUT THE INVENTION

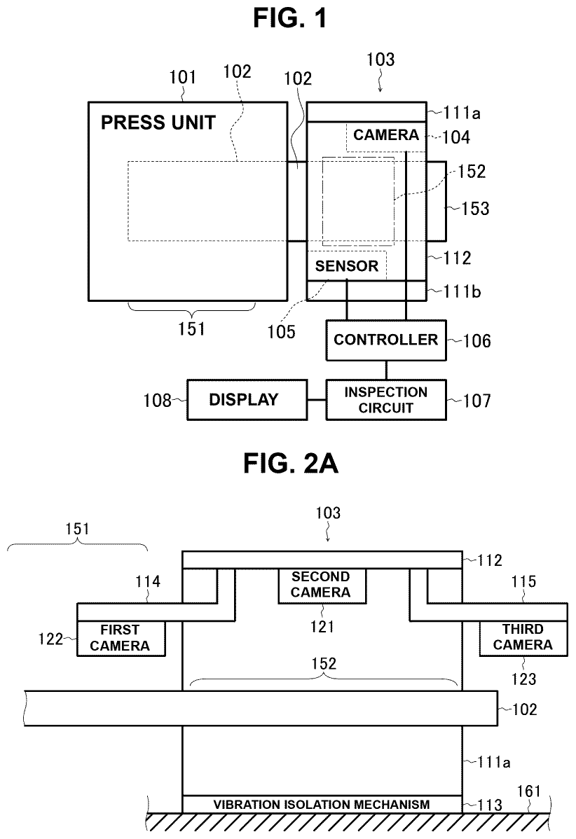

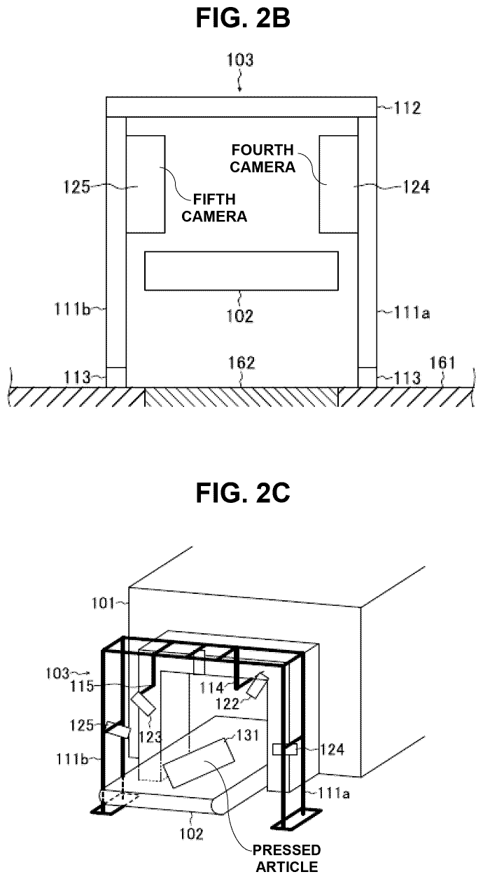

A press machine according to the embodiment of the present invention will now be described with reference to FIGS. 1, 2A, 2B, and 2C. FIG. 2A is a side view showing a part of the press machine viewed from a lateral direction parallel to the conveyance direction of a conveyance unit 102. FIG. 2B is a side view showing a part of the press machine viewed from a front direction perpendicular to the conveyance direction of the conveyance unit 102. As shown in FIG. 1, the press machine includes a press unit 101, the conveyance unit 102, a frame 103, an image capturing unit 104, a sensor 105, a controller 106, an inspection circuit 107, and a display 108. An inspection device is formed by the image capturing unit 104, the controller 106, and the inspection circuit 107. Note that, in general, the press machine is formed by the press unit 101 and the conveyance unit 102.

The press unit 101 executes press working of a vehicle body panel such as a dashboard lower panel by, for example, transfer press. The conveyance unit 102 conveys a pressed article 131 press-worked by the press unit 101 and discharged to a discharge region 151 on the lower side of the press unit 101 up to an unloading port 153. The pressed article 131 is an inspection target. The conveyance unit 102 is, for example, a belt conveyor. Alternatively, the conveyance unit 102 may be a chain conveyor, a roller conveyor, a screw conveyor, or an air floating conveyor.

For example, if the press unit 101 is of a transfer press type, the press unit 101 includes a press region where single-process dies are sequentially arranged, and press working is sequentially executed in the press region. In the press region, when one press working process is ended, the pressed article 131 is sent to the next press step by a conveyance mechanism such as a robot arm. The pressed article 131 that has undergone all press working processes is dropped to the discharge region 151 of the conveyance unit 102 arranged below the press region and conveyed to the unloading port 153 by the conveyance mechanism. In FIG. 1, the press unit 101 (press region) and the discharge region 151 are shown to overlap in a planar view. However, the press region and the discharge region 151 may be arranged in different regions in a planar view.

The frame 103 is arranged outside the press unit 101. For example, the press unit 101 is arranged on a press unit foundation 162, as is well known. The frame 103 can be arranged on a floor 161 outside the press unit foundation 162 on which the press unit 101 is installed. The image capturing unit 104 is installed on the frame 103 and captures an inspection region 152 of the conveyance unit 102. When the inspection region 152 of the conveyance unit 102 is captured, the pressed article 131 of the inspection target conveyed on the conveyance unit 102 is captured. Thus, since the image capturing unit 104 is attached to the frame 103 installed outside the press unit 101, appearance inspection can be executed while suppressing the influence of a vibration generated from the operating press unit 101 (press machine).

For example, since the press unit 101 is installed on the press unit foundation 162, the press vibration is transmitted from the press unit foundation 162 to the floor 161 while being dispersed/attenuated. The vibration transmitted to the frame 103 installed on the floor 161 outside the press unit 101 is dispersed/attenuated and is therefore small, and there is no influence on image capturing by the image capturing unit 104.

Also, the frame 103 can be installed on a vibration isolation mechanism or a seismic isolation mechanism. The vibration isolation mechanism or the seismic isolation mechanism can be arranged between the floor 161 and the frame 103. When the vibration isolation mechanism or the seismic isolation mechanism is used, the influence of the vibration generated from the operating press unit 101 can be suppressed more effectively. The vibration isolation mechanism has a structure for making it hard to transmit a vibration. The vibration isolation mechanism can be formed by, for example, a vibration isolation material such as rubber or a hydraulic mechanism.

For example, the frame 103 can include a first leg 111a and a second leg 111b, which are installed on the floor 161 on both sides of the conveyance unit 102, and a pair of beams 112 on the front and rear sides, which are laid between the first leg 111a and the second leg 111b while straddling the conveyance unit 102. In the frame 103 having such a portal shape, the beams 112 deflect, thereby absorbing the vibration transmitted from the floor 161 to the first leg 111a and the second leg 111b such that the vibration is canceled. It is therefore possible to more effectively suppress the vibration of the image capturing unit 104. For example, if a vibration isolation mechanism or a seismic isolation mechanism is used, the first leg 111a and the second leg 111b are installed on it.

The image capturing unit 104 can be formed by a first camera 121, a second camera 122, a third camera 123, a fourth camera 124, and a fifth camera 125. In addition, an illumination device configured to illuminate the direction of image capturing of each camera can be provided together with the camera.

The first camera 121 is attached to the beam 112 and captures the inspection region 152 from above. The second camera 122 is attached to a first bracket 114 that is supported by the beam 112 and enters the discharge region 151, and captures the inspection region 152 from the upstream side of the conveyance unit 102. The third camera 123 is attached to a second bracket 115 that is supported by the beam 112 and extends in the direction of the unloading port 153, and captures the inspection region 152 from the downstream side of the conveyance unit 102.

The fourth camera 124 is attached to the first leg 111a. The fifth camera 125 is attached to the second leg 111b. The fourth camera 124 and the fifth camera 125 capture the inspection region 152 from both sides with respect to the conveyance direction of the conveyance unit 102. Note that the number of cameras is not limited to one, and each camera may comprise two or three cameras. Using many cameras, even if the pressed article 131 is a large vehicle body part such as a dashboard lower panel, the whole surface of the part can be captured, and the quality of the outer appearance can be determined.

Since a large pressed article such as a dashboard lower panel has a height and a complex shape, more cameras are necessary. The larger the number of cameras is, the longer the time required for information processing for inspection is, and the longer the time required for quality inspection is. However, in a case of a large pressed article, since the press processing time necessary for one pressed article is long, the number of pressed articles discharged to the conveyance unit 102 per unit time is small. Hence, the conveyance speed in the conveyance unit 102 is low. Thus, in a case of a large pressed article, since the conveyance speed is low, quality inspection using many cameras can be performed.

On the other hand, in a case of a small pressed article, since the press processing time necessary for one pressed article is short, the number of pressed articles discharged to the conveyance unit 102 per unit time is small Hence, the conveyance speed in the conveyance unit 102 is high. However, in a case of a small pressed article, the number of cameras necessary for quality inspection can be small. For example, quality inspection can be executed using two cameras. Thus, when the number of cameras is small, information processing for inspection can be performed in a short time. For this reason, even if the pressed article is conveyed at a relatively high speed, quality inspection can be completed.

As described above, when the number of cameras to be used is changed depending on the state of the pressed article, appropriate inspection can be executed. For example, the controller 106 can select, based on the identification information of the pressed article 131, cameras to start image capturing from the first camera 121, the second camera 122, the third camera 123, the fourth camera 124, and the fifth camera 125, start image capturing by the selected cameras, and acquire the image of the pressed article 131 passing through the inspection region.

By using the thus configured controller 106, for example, if a feature part of the large pressed article 131 is located on a vertical wall, the feature part cannot be captured by the camera (first camera 121) on the upper side and, therefore, the second camera 122, the third camera 123, the fourth camera 124, and the fifth camera 125 on the side and front/rear sides are used. If the pressed article 131 is large and has a lot of feature parts, all the first camera 121, the second camera 122, the third camera 123, the fourth camera 124, and the fifth camera 125 are selected and used. If the pressed article 131 is small or flat, inspection can be executed based on an image obtained by image capturing using only the first camera 121.

Here, when the first leg 111a, the second leg 111b, and the beams 112 have a predetermined width in the conveyance direction of the conveyance unit 102, the first bracket 114 and the second bracket 115 can be more firmly fixed to the beam 112. Also, two sets of the first legs 111a, the second legs 111b, and the beams 112 may be provided at a predetermined interval in the conveyance direction of the conveyance unit 102. In this case, the first bracket 114 and the second bracket 115 are laid between the two beams 112, thereby suppressing vibrations in the first bracket 114 and the second bracket 115.

Also, since inspection is executed in the conveyance unit 102 in which the distance of conveyance is limited, the length of the inspection region 152 is also limited. When the camera is installed using the first bracket 114 so as to enter to the side of the press unit 101 and the discharge region 151, a wider region in the conveyance unit 102 can be set to the inspection region 152. As a result, parts of a variety sizes can be used as the inspection target. In addition, since the camera is installed using the first bracket 114 so as to enter to the side of the press unit 101 and the discharge region 151, the pressed article 131 having a large size and a complex shape can be captured from the side of the press unit 101.

The sensor 105 detects that the pressed article 131 conveyed by the conveyance unit 102 reaches the inspection region 152. If the sensor 105 detects that the pressed article 131 reaches the inspection region 152, the controller 106 starts image capturing by the image capturing unit 104 and acquires the image of the pressed article 131 passing through the inspection region 152.

The inspection circuit 107 inspects the outer appearance of the pressed article 131 based on the image of the pressed article 131 acquired by the controller 106. The inspection circuit 107 compares a registered non-defective article image with the captured image, thereby executing quality determination of the pressed article 131. For example, the inspection circuit 107 executes quality determination of the pressed article 131 by using a determination model produced by machine learning based on defective article images obtained by capturing the pressed articles 131 that can be non-defective articles and non-defective article images obtained by capturing the pressed articles 131 that can be defective articles.

The press-worked pressed article is extracted by a robot arm (not shown), dropped onto the conveyance unit 102 in the discharge region 151, and discharged. Hence, the pressed article 131 dropped on the conveyance unit 102 is not in a predetermined posture. When determining the quality based on the captured image, it is generally preferable that the pressed article has a predetermined posture in the viewpoint of the determination processing speed and the determination accuracy. It is therefore considered that, for example, a positioning mechanism for image capturing is provided. However, if a positioning process using such a positioning mechanism is provided, productivity lowers.

To perform quality determination without lowering the determination processing speed and the determination accuracy and without lowering productivity, the inspection circuit 107 recognizes the posture of the pressed article 131 in the captured image of the pressed article 131, and executes quality determination of the outer appearance of the pressed article 131 based on machine learning data obtained by machine learning corresponding to the recognized posture. For example, the inspection circuit 107 can extract feature parts of the pressed article 131 in the captured image of the pressed article 131 and recognize the posture of the pressed article 131 based on the extracted feature parts.

As the feature parts, first, a part end portion shape (edge portion) and a hue can be exemplified. As the feature parts, second, a part hole position and a remarkably noticeable shape can be exemplified. As the feature parts, third, an overall shape can be exemplified. In particular, when a part hole position, a remarkably noticeable shape, and the like are used as the feature parts, the information processing amount is small, and the processing speed can be improved. In addition, when the one and only portion in the image capturing range of each camera is selected as the feature part, which pressed article is the inspection target can be specified.

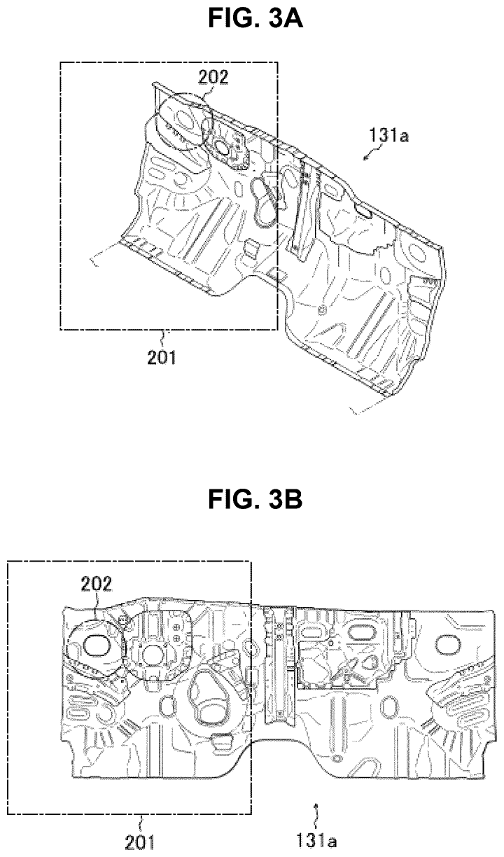

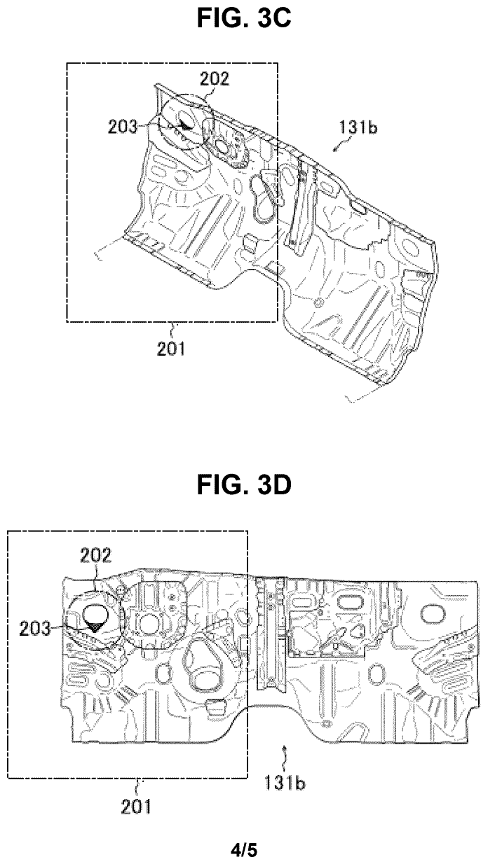

An example of quality determination will be described here with reference to FIGS. 3A, 3B, 3C, and 3D. As the pressed article 131, a dashboard lower part will be described below as an example.

For example, based on an image of an OK pressed article 131a in an image capturing range 201 that can be captured by a camera, a feature part 202 is decided by combining as a hole position, a shape line, and the like, which are characteristic portions. In addition, information of a posture is associated with the results of image capturing of the OK pressed article 131a in various posture states based on the coordinates of the decided feature part 202, an OK determination model is created for each posture, and the inspection circuit 107 is caused to learn it (FIGS. 3A and 3B). In the results of image capturing in various postures, the coordinate positions of the feature part 202 in the captured images are different between the postures. Hence, the posture of the image capturing target can be specified based on the coordinate information of the feature part 202 in the image capturing range 201.

In addition, information of a posture is associated with the results of image capturing of a defective pressed article 131b in various posture states based on the coordinates of the decided feature part 202, an NG determination model is created for each posture, and the inspection circuit 107 is caused to learn it (FIGS. 3C and 3D). In this example, an underfill 203 occurs in the feature part 202. For example, the captured image and an OK determination model with a matching posture are compared by image analysis software, thereby determining that the captured pressed article is defective. A determination model obtained from the corresponding image can be defined as an NG determination model. The defective pressed article 131b that is artificially decided can also be used.

The above-described creation of the OK determination model and the NG determination model for each posture is performed for the image capturing result of each camera.

In actual inspection, an OK determination model and a NG determination model corresponding to the posture decided from the feature part are selected for an inspection image.

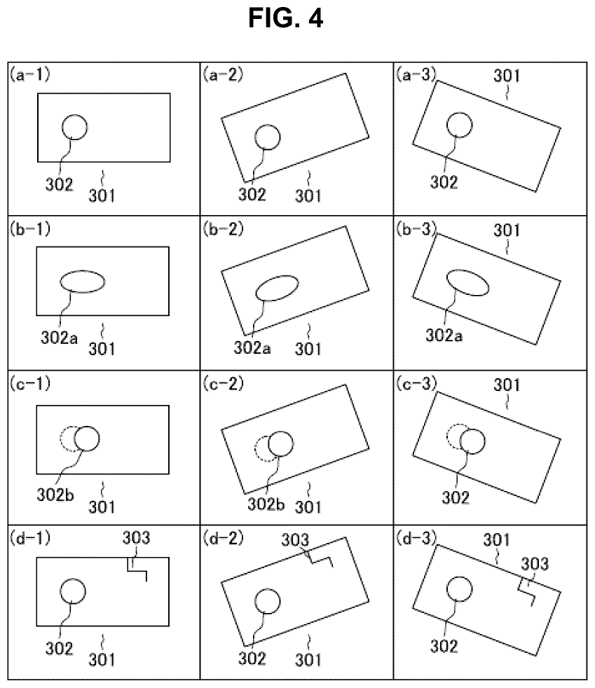

For example, as shown in FIG. 4, for an OK model (a-1) in first posture by a pressed article image 301 and a normal feature part 302, an NG model (b-1) by a feature part 302a having different shape, an NG model (c-1) by a feature part 302b with position deviation, and an NG model (d-1) including a crack 303 can be set.

Also, for an OK model (a-2) in second posture by the pressed article image 301 and the normal feature part 302, an NG model (b-2) by the feature part 302a having different shape, an NG model (c-2) by the feature part 302b with position deviation, and an NG model (d-2) including the crack 303 can be set.

In addition, for an OK model (a-3) in third posture by the pressed article image 301 and the normal feature part 302, an NG model (b-3) by the feature part 302a having different shape, an NG model (c-3) by the feature part 302b with position deviation, and an NG model (d-3) including the crack 303 can be set.

The inspection target image is compared with each of the selected OK determination model and NG determination model. If the degree of matching with the NG determination model is higher as the result of comparison, it is determined as NG. The determination accuracy can be improved by increasing the number of posture types and learning more determination models. Similarly, since where a defect such as an underfill, a crack, or break-through occurs cannot be known, every time an NG article occurs, the data is set as an NG determination model, thereby performing learning and improving the determination accuracy.

Particularly, when a plurality of images obtained by capturing the inspection region 152 from above, from sides, from the upstream side, and from the downstream side using the first camera 121, the second camera 122, the third camera 123, the fourth camera 124, and the fifth camera 125 are used, recognition of a posture in the inspection circuit 107 can be executed at higher accuracy. Also, even if the pressed article is large, the outer appearance of the whole pressed article can be inspected based on a small region, and the conveyance unit (inspection region) can be made short.

Also, the inspection circuit 107 can control the operation of the press unit 101 based on the inspection result of the outer appearance of the pressed article 131. For example, if the determination result is “defective”, the inspection circuit 107 stops the operation of the press unit 101. In addition, the inspection circuit 107 stops the operation of the conveyance unit 102. By stopping the operation of the press unit 101, it is possible to suppress occurrence of further defective articles.

The inspection result of the inspection circuit 107 is displayed on the display 108. For example, if the determination result is “defective”, the portion of the pressed article 131 determined as defective is surrounded by a frame and displayed on the display 108. The operator confirms the display on the display 108, thereby excluding defective articles. In addition, the operator confirms other inspection items, thereby reducing loads on the cameras and thus enabling inspection at a higher speed and improving productivity. Furthermore, based on the information of the defective article displayed on the display 108, control change of the press unit, for example, condition change of press working can be executed.

Note that the inspection circuit 107 is a computer device including a CPU (Central Processing Unit), a main storage device, and an external storage device, and the above-described functions of the inspection circuit 107 can be implemented by the CPU operating based on a program loaded in the main storage device (executing the program). The program is a program used by the computer to execute the functions of the inspection circuit 107.

As described above, according to the present invention, the image capturing unit is attached to the frame installed on the floor via a vibration isolation mechanism. It is therefore possible to execute appearance inspection while suppressing the influence of a vibration generated from the operating press unit. Since the vibration generated from the press unit can be suppressed, image capturing can be performed near the press unit, and the press machine including the inspection device can be made compact.

Some or all of the above-described embodiment can also be described as in the following supplementary notes but are not limited to the followings.

### Supplementary Note 1]

There is provided a press machine comprising a conveyance unit configured to convey, up to an unloading port, a pressed article that is press-worked by a press unit, dropped to a discharge region below the press unit, and discharged, and is not in a predetermined posture, a frame installed outside the press unit, an image capturing unit installed on the frame and configured to capture an inspection region of the conveyance unit, a sensor configured to detect that the pressed article conveyed by the conveyance unit reaches the inspection region, a controller configured to, when the sensor detects that the pressed article reaches the inspection region, start image capturing by the image capturing unit and acquire an image of the pressed article passing through the inspection region, an inspection circuit configured to inspect an outer appearance of the pressed article based on the image of the pressed article acquired by the controller, and a display configured to display an inspection result by the inspection circuit, wherein the inspection circuit decides a posture of the pressed article based on a feature part of the pressed article, the feature part is at least one of center coordinates of a plurality of holes, characteristic shape coordinates, and shape coordinates of a part end portion, and the inspection circuit recognizes the posture of the pressed article in the captured image of the pressed article based on the feature part, and executes quality determination of the outer appearance of the pressed article based on machine learning data obtained by machine learning corresponding to the recognized posture.

### [Supplementary Note 2]

In the press machine according to Supplementary Note 1, the posture of the pressed article is the posture of the pressed article that is press-worked, extracted by a robot arm, dropped onto the conveyance unit in the discharge region, and discharged.

### [Supplementary Note 3]

In the press machine according to Supplementary Note 1 or 2, the inspection circuit decides the posture of the pressed article based on coordinate information of the feature part in an image capturing range of the image capturing unit.

### [Supplementary Note 4]

In the press machine according to any one of Supplementary Notes 1 to 3, the inspection circuit associates information of a posture with results of image capturing of the pressed article in various posture states by the image capturing unit based on the coordinates of the decided feature part, creates an OK determination model and an NG determination model for each associated posture, and performs learning.

### [Supplementary Note 5]

In the press machine according to any one of Supplementary Notes 1 to 4, the inspection circuit compares the image captured by the image capturing unit and one of an OK determination model and an NG determination model with a matching posture by image analysis software, thereby determining that the captured pressed article is non-defective or defective.

### [Supplementary Note 6]

In the press machine according to Supplementary Note 4 to 5, the NG determination model includes an NG model by the feature part having a different shape, an NG model by the feature part with a position deviation, and an NG model including a crack.

### [Supplementary Note 7]

In the press machine according to any one of Supplementary Notes 1 to 6, the image capturing unit comprises a plurality of cameras and captures the inspection region from above, from sides, from an upstream side, and from a downstream side, and the inspection circuit inspects the outer appearance of the pressed article using a plurality of captured images.

### [Supplementary Note 8]

In the press machine according to Supplementary Note 7, at least one of the plurality of cameras is installed using a bracket to enter a side of the discharge region of the press unit.

### [Supplementary Note 9]

In the press machine according to Supplementary Note 7 or 8, the inspection circuit associates information of a posture with results of image capturing of the pressed article in various posture states by the plurality of cameras based on the coordinates of the decided feature part, creates an OK determination model and an NG determination model for each associated posture, performs learning, and compares the image and one of an OK determination model and an NG determination model with a matching posture by image analysis software, thereby determining that the pressed article is non-defective or defective.

### [Supplementary Note 10]

In the press machine according to any one of Supplementary Notes 7 to 9, the frame is installed outside a press unit foundation on which the press unit is installed, and comprises legs that are installed on a floor on both sides of the conveyance unit, and a beam that is laid between the legs while straddling the conveyance unit, and the image capturing unit comprises a first camera attached to the beam and configured to capture the inspection region from above, a second camera attached to a first bracket that is supported by the beam and enters the discharge region, and configured to capture the inspection region from the upstream side of the conveyance unit, a third camera attached to a second bracket that is supported by the beam and extends in a direction of the unloading port, and configured to capture the inspection region from the downstream side of the conveyance unit, and a fourth camera and a fifth camera, which are attached to the legs and configured to capture the inspection region from both sides with respect to a conveyance direction of the conveyance unit.

Note that the present invention is not limited the above-described embodiments, and it is obvious that many modifications and combinations can be done by any person ordinarily skilled in the art without departing from the technical scope of the present invention.

Explanation of the Reference Numerals and Signs

101 . . . press unit, 102 . . . conveyance unit,
103 . . . frame, 104 . . . image capturing unit, 105 . . . sensor,
106 . . . controller, 107 . . . inspection circuit,
108 . . . display, 111a . . . first leg, 111b . . . second leg,
112 . . . beam, 113 . . . vibration isolation mechanism,
114 . . . first blanket, 115 . . . second blanket, 121 . . . first
camera, 122 . . . second camera, 123 . . . third camera,
124 . . . fourth camera, 125 . . . fifth camera, 151 . . . discharge
region, 152 . . . inspection region, 153 . . . unloading port,
161 . . . floor.

1. A press machine comprising:
a pressing device configured to perform press-working to an article and drop a pressed article to a discharge region below;
a conveyor configured to convey, up to an unloading port, the pressed article dropped to the discharge region below the pressing device;
a frame installed outside the pressing device;
an imaging device installed on the frame and configured to capture an inspection region of the conveyor;
a sensor configured to detect that the pressed article conveyed by the conveyor reaches the inspection region;
a controller configured to control the imaging device such that the imaging device, when the sensor detects that the pressed article reaches the inspection region, start image capturing and acquire an image of the pressed article passing through the inspection region;
an inspection circuit configured to inspect an outer appearance of the pressed article based on the image of the pressed article acquired by imaging device under control of the controller; and
a display configured to display an inspection result by the inspection circuit,
wherein
the inspection circuit decides a posture of the pressed article based on a feature part of the pressed article,
the feature part is at least one of center coordinates of a plurality of holes, characteristic shape coordinates, and shape coordinates of a part end portion, and
the inspection circuit is configured to associate information of a posture with images of the pressed article in various postures captured by the imaging device based on the coordinates of the decided feature part, creates an OK determination model and an NG determination model for each associated posture, and performs learning,
wherein the inspection circuit recognizes the posture of the pressed article in the captured image of the pressed article based on the feature part, and executes quality determination of the outer appearance of the pressed article based on machine learning data obtained by machine learning corresponding to the recognized posture.

2. (canceled)

3. The press machine according to claim 1, wherein
the inspection circuit decides the posture of the pressed article based on coordinate information of the feature part in an image capturing range of the imaging device.

4. (canceled)

5. The press machine according to claim 1, wherein
the inspection circuit compares the image captured by the imaging device and one of an OK determination model and an NG determination model with a matching posture by image analysis software, thereby determining that the captured pressed article is non-defective or defective.

6. The press machine according to claim 1, wherein
the NG determination model includes an NG model by the feature part having a different shape, an NG model by the feature part with a position deviation, and an NG model including a crack.

7. The press machine according to claim 1, wherein
the imaging device comprises a plurality of cameras and captures the inspection region from above, from sides, from an upstream side, and from a downstream side, and
the inspection circuit inspects the outer appearance of the pressed article using a plurality of captured images.

8. The press machine according to claim 7, wherein
at least one of the plurality of cameras is installed using a bracket to enter a side of the discharge region of the pressing device.

9. The press machine according to claim 7, wherein
the inspection circuit associates information of a posture with results of image capturing of the pressed article in various posture states by the plurality of cameras based on the coordinates of the decided feature part, creates an OK determination model and an NG determination model for each associated posture, performs learning, and compares the image and one of the OK determination model and the NG determination model with a matching posture by image analysis software, thereby determining that the pressed article is non-defective or defective.

10. The press machine according to claim 7, wherein
the frame is installed outside a pressing device foundation on which the pressing device is installed, and comprises legs that are installed on a floor on both sides of the conveyor, and a beam that is laid between the legs while straddling the conveyor, and
the imaging device includes:
a first camera attached to the beam and configured to capture the inspection region from above;
a second camera attached to a first bracket that is supported by the beam and enters the discharge region, and configured to capture the inspection region from the upstream side of the conveyor;
a third camera attached to a second bracket that is supported by the beam and extends in a direction of the unloading port, and configured to capture the inspection region from the downstream side of the conveyor; and
a fourth camera and a fifth camera, which are attached to the legs and configured to capture the inspection region from both sides with respect to a conveyance direction of the conveyor.

11. The press machine according to claim 1, wherein
the posture of the pressed article is the posture of the pressed article that is press-worked, extracted by a robot arm, dropped onto the conveyance unit in the discharge region, and discharged.

12. The press machine according to claim 5, wherein
the NG determination model includes an NG model by the feature part having a different shape, an NG model by the feature part with a position deviation, and an NG model including a crack.
